(19) United States
(12) Patent Application Publication
(10) Pub. No.: US 2008/0206491 A1
(43) Pub. Date: Aug. 28, 2008

(54) Double-Sided Pressure-Sensitive Adhesive Tape For Producing Lc Displays With Light-Reflecting and Light-Absorbing Properties

(75) Inventors: Marc Husemann, Hamburg (DE); Reinhard Storbeck, Hamburg (DE)

Correspondence Address: NORRIS, MCLAUGHLIN & MARCUS, 875 THIRD AVE, 18TH FLOOR, NEW YORK, NY, 10022, US

(73) Assignee: TESA AG, Hamburg (DE)

(21) Appl. No.: 11/917,177

(22) PCT Filed: Dec. 2, 2005
(86) PCT No.: PCT/EP2005/056410

§ 371 Date: Mar. 25, 2008

(30) Foreign Application Priority Data
Jul. 21, 2005 (DE) 10 2005 034 746.0

(51) Int. Cl. C09K 19/00; B32B 7/12; B29C 65/00

(52) U.S. Cl. 428/1.5; 428/354; 156/60

(57) ABSTRACT

A pressure-sensitive adhesive (PSA) tape, particular for producing or bonding optical liquid-crystal data displays, having two PSA layers (b, b′) and at least one carrier sheet (a), wherein the PSA tape has light-reflecting properties on both its top and bottom faces and at the same time is light-absorbing at least in so far as light not reflected is unable to penetrate the adhesive tape. The PSA tape is implemented in particular in such a way that at least between one face of the carrier sheet and the PSA layer located on that face there is a white paint layer (c). As a preference, a metallic layer (d) is provided between the carrier sheet and the white paint layer.

The invention relates to double-sided pressure-sensitive adhesive tapes having multilayer carrier constructions, having multilayer pressure-sensitive adhesive constructions, and having light-reflecting and absorbing properties for producing liquid-crystal displays (LCDs).

Pressure-sensitive adhesive tapes in the age of industrialization are widespread processing auxiliaries. Particularly for use in the computer industry, very exacting requirements are imposed on pressure-sensitive adhesive tapes. As well as having a low outgassing behavior, the pressure-sensitive adhesive tapes ought to be suitable for use across a wide temperature range and ought to fulfill certain optical properties.

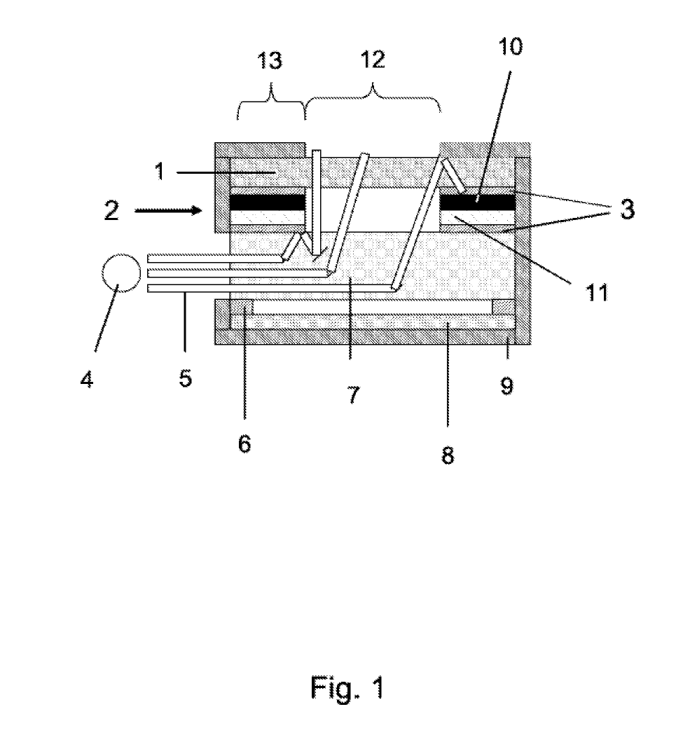

One field of use is that of optical liquid-crystal data displays (LCDs) which are needed for computers, TVs, laptops, PDAs, cellphones, digital cameras, etc. FIG. 1 shows the approach for a double-sided adhesive tape having a black layer for absorption and a layer for reflection, in accordance with the prior art; the key to the reference numerals is as follows:

| | |
|---|---|
| 1 | LCD glass |
| 2 | double-sided black-white adhesive tape |
| 3 | pressure-sensitive adhesive |
| 4 | light source (LED) |
| 5 | light beams |
| 6 | double-sided adhesive tape |
| 7 | optical waveguide |
| 8 | reflective film |
| 9 | LCD casing |
| 10 | black absorbing side of adhesive tape |
| 11 | reflecting side |
| 12 | visible region |
| 13 | “blind” region |

For the production of LC displays, LEDs (light-emitting diodes), as the light source, are bonded to the LCD module. Generally, black, double-sided pressure-sensitive adhesive tapes are used for this purpose. The aim of the black coloration is to prevent light penetrating from inside to outside and vice versa in the region of the double-sided pressure-sensitive adhesive tape.

There are already numerous approaches in existence for achieving such black coloring. On the other hand, there is a desire to increase the light efficiency of the back light module, and so it is preferred to use double-sided adhesive tapes which are black (light-absorbing) on one side and light-reflecting on the other side.

For the production of the black side there are numerous approaches in existence.

One approach to the production of black double-sided pressure-sensitive adhesive tapes lies in the coloration of the carrier material. Within the electronics industry great preference is attached to using double-sided pressure-sensitive adhesive tapes having polyester film carriers (PET), on account of their very good diecuttability. The PET carriers can likewise be colored with carbon black or black pigments, in order to achieve light absorption. The disadvantage of this existing approach is the low level of light absorption. In very thin carrier layers it is possible to incorporate only a relatively small number of particles of carbon black or other black pigment, with the consequence that absorption of the light is incomplete. With the eye, and also with relatively intensive light sources (with a luminance of greater than 600 candelas), it is then possible to determine the deficient absorption.

In the development of LC displays there is a trend developing. On the one hand, the LC displays are to become more lightweight and flatter, and there is a rising demand for ever larger displays with ever higher resolution.

For this reason, the design of the displays has been changed, and the light source, accordingly, is coming nearer and nearer to the LCD panel, with the consequence of an increased risk of more and more light penetrating from the outside into the marginal zone (“blind area”) of the LCD panel (cf. FIG. 1). With this development, therefore, there is also an increase in the requirements imposed on the shading properties (blackout properties) of the double-sided adhesive tape, and accordingly there is a need for new approaches for adhesive tapes.

On the other hand, moreover, the double-sided adhesive tape is to be reflecting.

Known for this purpose are double-sided pressure-sensitive adhesive tapes which have a metallic layer on one side and a black carrier. With these pressure-sensitive adhesive tapes, a distinct improvement has been obtained in respect of light reflection on one side and absorption on the opposite side, and yet, as a result of the antiblocking agents in the carrier layer, irregularities occur in the reflecting side.

To obtain a reflecting layer, then, it is possible to provide the pressure-sensitive adhesive (PSA) with reflecting particles. The reflecting properties obtainable, however, are only relatively inadequate.

JP 2002-350612 describes double-sided adhesive tapes for LCD panels with light-protecting properties. The function is achieved by means of a metal layer applied on one or both sides to the carrier film, it also being possible, additionally, for the carrier film to have been colored. As a result of the metalization, the production of the adhesive tape is relatively costly and inconvenient, and the adhesive tape itself possesses a deficient flat lie.

DE 102 43 215 A describes double-sided adhesive tapes for LC displays that have light-absorbing properties on the one side and light-reflecting properties on the other side. That document describes black/silver double-sided PSA tapes. A transparent or colored carrier film is metalized on one side and colored black on the other side. In this way, good reflecting properties are already achieved, but deficient absorbing properties as well are achieved, since defects, arising out of the film as a result of antiblocking agents, for example, can only be coated over, and hence the light can still shine through at these points (pinholes).

For the adhesive bonding of LC displays and for their production, therefore, there continues to be a need for double-sided pressure-sensitive adhesive tapes which do not have the deficiencies described above, or which have them only to a reduced extent.

It is hence an object of the invention to provide a double-sided pressure-sensitive adhesive tape which avoids the presence of pinholes, which is capable of completely absorbing light, and which features improved reflection of light.

This object is achieved by means of the pressure-sensitive adhesive tapes of the invention as set out in the main claim. In the context of this invention it has surprisingly been found that with a film which is metalized at least on one side and provided at least with one white coating layer it is possible to achieve these properties. The dependent claims relate to advantageous embodiments of the subject matter of the invention, and also to the use of the pressure-sensitive adhesive tapes of the invention.

Both on its top side and on its bottom side, the pressure-sensitive adhesive tape of the invention displays light-reflecting properties and is preferably at the same time light-absorbing at least insofar as light which is not reflected is unable, or able only to a reduced extent, to penetrate the adhesive tape.

Set out below are some advantageous embodiments of the adhesive tape of the invention, without wishing any unnecessary restriction to be imposed through the choice of the examples.

The pressure-sensitive adhesive layers (b) and (b′) on the two sides of the pressure-sensitive adhesive tape of the invention can in each case be identical or different, particularly with regard to their configuration (layer thickness and the like) and their chemical composition. With particular preference the pressure-sensitive adhesive on both sides of the pressure-sensitive adhesive tape is transparent. In the inventive sense, however, it can also be advantageous to color the pressure-sensitive adhesives white on both sides of the pressure-sensitive adhesive tape.

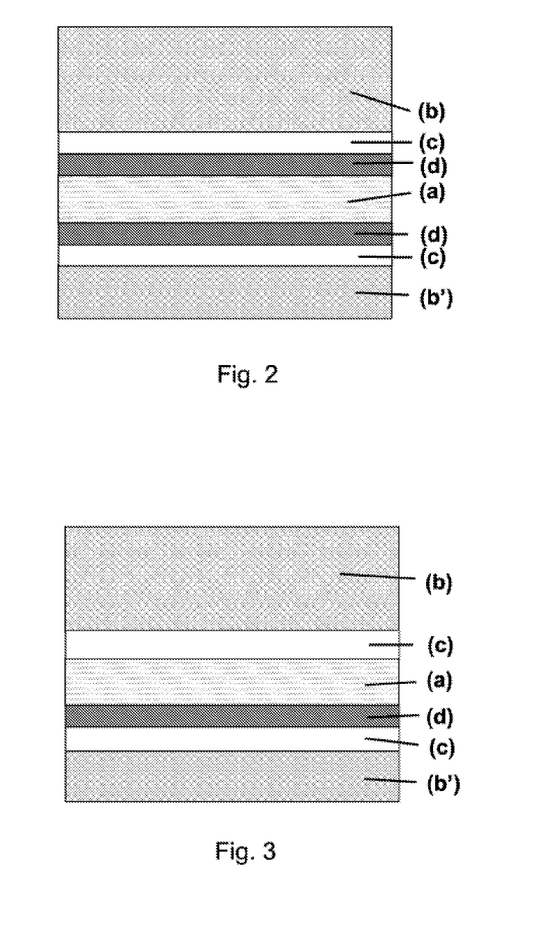

In a first advantageous embodiment the inventive pressure-sensitive adhesive tape is composed of a carrier film layer (a), two white chromophoric coating layers (c), two metallic layers (d), and two transparent pressure-sensitive adhesive layers (b) and (b′). This embodiment is shown in FIG. 2.

In a further preferred embodiment, as shown by FIG. 3, the double-sided pressure-sensitive adhesive tape is composed of a carrier film (a), two white chromophoric coating layers (c), a metallic layer (d), and two pressure-sensitive adhesive layers (b) and (b′). The invention is elucidated further below. The limiting values specified are to be understood as inclusive values, in other words as included within the specified limiting range.

The pressure-sensitive adhesive tapes of the invention can additionally be characterized as follows:

The carrier film (a) is preferably between 5 and 250 μm, more preferably between 8 and 50 μm, most preferably between 12 and 36 μm thick and is preferably transparent, white or semitransparent. The film can, however, also be differently colored, in order to reduce the light transmittance of the adhesive tape. The coating layers (c) are light-reflecting and at the same time light-absorbent.

The thickness of the layers (c) is preferably between 1 μm and 15 μm and they can also consist of two or more coating layers.

The thickness of the layer(s) (d) is preferably between 0.01 μm and 5 μm. Here, in one particularly preferred version, aluminum or silver is applied to the carrier film (a) by vapor coating.

The PSA layers (b) and (b′) preferably possess a thickness of in each case between 5 μm and 250 μm. The individual layers (a), (c), (d), (b), and (b′) may differ in terms of thickness within the double-sided pressure-sensitive adhesive tape, with the consequence that it is possible, for example, to apply PSA layers (b) and (b′) of different thickness, or that individual layers, two or more layers or else all the layers can be chosen identically.

### Carrier Film (a)

As film carriers it is possible in principle to use all filmlike polymer carriers which are transparent, semitransparent or colored. Thus it is possible, for example, to use polyethylene, polypropylene, polyimide, polyester, polyamide, polymethacrylate, fluorinated polymer films, etc. In one particularly preferred embodiment, polyester films are used, with particular preference PET films (polyethylene terephthalate). The films may be present in detensioned form or may have one or more preferential directions. Preferential directions are obtained by drawing in one or in two directions. Normally, for the production operation of films, PET films for example, antiblocking agents are employed, such as silicon dioxide, silica chalk, chalk or zeolites, for example.

Antiblocking agents are intended to prevent the sticking together of flat polymer films under pressure and temperature to form blocks. The antiblocking agents are typically incorporated into the thermoplastic mix. In that case the particles function as spacers.

Films of this kind can be employed with advantage for the inventive double-sided adhesive tapes. For the inventive pressure-sensitive adhesive tapes, however, it is also possible to use films which contain no antiblocking agents or contain them only in a very small proportion. One example of such films is the Hostaphan™ 5000 series from Mitsubishi Polyester Film (PET 5211, PET 5333 PET 5210), for example.

Moreover, very thin PET films, examples being PET films 6 or 12 μm thick, are distinctly preferred on account of the fact that they allow very good technical adhesive properties for the double-sided adhesive tape, since in this case the film is very flexible and is able to conform very well to the surface roughnesses of the substrates where adhesive bonding is to take place.

To improve the anchoring of the coating layers it is very advantageous if the films are pretreated. The films may have been etched (e.g., trichloroacetic acid or trifluoroacetic acid), corona- or plasma-pretreated, or finished with a primer (e.g., Saran).

Furthermore, it is possible and advantageous—particularly when the film material is transparent or semitransparent—to add color pigments or chromophoric particles to the film material. Thus, for example, titanium dioxide and barium sulfate are suitable for white coloring. The pigments or particles ought, however, to be preferably always smaller in diameter than the final layer thickness of the carrier film. Optimum colorations can be achieved with 10% to 40% by weight particle fractions, based on the film material.

### Coating Layer (c)

The coating layer (c) fulfills various functions. In one version of the invention the color layer possesses the function of additional absorption of external light. In this case, therefore, for the double-sided pressure-sensitive adhesive tape, the transmittance in a wavelength range of 300-800 nm must be situated at <0.5%, more preferably at <0.1%, most preferably at <0.01%.

In a further function the coating layer (c) fulfills light reflection. The light reflection according to test method c ought to be greater than 65%.

In one very preferred version this is achieved with a white coating layer.

Coating materials may be coated as 100% systems, from solution or from dispersion.

Coating materials are composed of a curing binder matrix (preferably thermosetting system, or alternatively radiation-curing system) and white color pigments and are then applied with a printing unit (by flexographic printing, for example). In order to achieve sufficient opacity this can also be done in two or more steps and hence two or more layers of printing ink can be applied. Furthermore, the ink can also be applied using an engraved-roll applicator unit. With this it is possible to apply relatively high layer thicknesses of ink in one step.

The coating materials may be based, for example, on polyesters, polyurethanes, polyacrylates or polymethacrylates. In addition it is possible to add coatings additives that are known to the skilled worker. The coating material, moreover, a crosslinking component for curing, which either is activated via radiation curing (EB curing, e.g., difunctional or polyfunctional vinylic compounds, UV curing, e.g., in conjunction with UV photocation generators difunctional or polyfunctional epoxides, or with UV free-radical generators according to Norrish I or II type in turn difunctional or polyfunctional vinylic compounds, such as acrylates or methacrylates) or thermally activable compounds, such as difunctional or polyfunctional isocyanates, difunctional or polyfunctional epoxides, difunctional or polyfunctional hydroxides, for example, according to dependence on the base matrix of the coating material.

In one inventive version which is very much to be preferred, titanium dioxide or barium sulfate are mixed as chromophoric particles into the coating layer. With a very high level of additization (>20% by weight), this additization produces not only complete light absorption but also light reflection. The particle size distribution of the white color pigments is very important for the optimum coloring of the coating layer (c). Thus the particles ought at least to be smaller than the total thickness of the coating layer (c). One preferred version uses particles having an average diameter of 50 nm to 5 μm, more preferably between 100 nm and 3 μm, most preferably between 200 nm and 1 μm.

Grades of this kind can be obtained, for example, by controlled milling in ball mills, with subsequent controlled screening. A further requirement for the quality of the coloration is the homogeneous distribution of the color particles in the coating layer. For this it is necessary to employ an intensive mixing operation, which in one optimum version entails mixing using the Ultraturrax. With this step it is then possible again to break down the color particles and homogenize them in the white coating material.

### Metallic Layer (d)

For the production of a highly reflecting and light-absorbing side it is possible on the one hand to apply a silver-colored coating material to the film layer (a) or to vapor-coat the film layer (a) on one side or both sides with a metal, aluminum or silver for example. For the silver-colored coating material version, a binder matrix is blended with silver color pigments. Examples of suitable binder matrixes include polyurethanes or polyesters, which have a high refractive index and a high transparency. Alternatively the color pigments can be incorporated into a polyacrylate or polymethacrylate matrix and then cured as coating material.

In one very preferred version the film layer (a) is vapor-coated on both sides with aluminum or silver. In order to achieve particularly outstanding reflecting properties, the sputtering operation for vapor coating must be controlled in such a way that the aluminum or silver is applied very uniformly, in order to obtain optimum reflection (avoidance of scattering effects). Moreover, in one very preferred embodiment, the PET film in pretreated by plasma or corona before vapor-coating with aluminum or silver is carried out. As a result of the use of the reflecting layer (b), on the one hand the light is targetedly reflected and on the other hand the transmittance of the light through the carrier material is reduced or avoided and also surface roughnesses of the carrier film are compensated.

PSAs (b) and (b′)

The PSAs (b) and (b′) are in one preferred embodiment identical on both sides of the pressure-sensitive adhesive tape. In one specific embodiment, however, it may also be of advantage if the PSAs (b) and (b′) differ from one another, more particularly in their layer thickness and/or their chemical composition. Thus in this way it is possible, for example, to set different pressure-sensitive adhesion properties. As PSA systems for the inventive double-sided pressure-sensitive adhesive tape it is preferred to use acrylate, natural-rubber, synthetic-rubber, silicone or EVA adhesives. The PSA has a high transparency or is colored white.

Furthermore, it is also possible to process the other PSAs known to the skilled worker, as are recited in, for example, the “Handbook of Pressure Sensitive Adhesive Technology” by Donatas Satas (van Nostrand, N.Y. 1989).

For natural-rubber adhesives the natural rubber is preferably milled to a molecular weight (weight average) of not below about 100 000 daltons, preferably not below 500 000 daltons, and additized.

In the case of rubber/synthetic rubber as starting material for the adhesive, there are wide possibilities for variation. Use may be made of natural rubbers or of synthetic rubbers, or of any desired blends of natural rubbers and/or synthetic rubbers, it being possible for the natural rubber or natural rubbers to be chosen in principle from all available grades, such as, for example, crepe, RSS, ADS, TSR or CV types, in accordance with the purity level and viscosity level required, and for the synthetic rubber or synthetic rubbers to be chosen from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible, in order to improve the processing properties of the rubbers, to add to them thermoplastic elastomers with a weight fraction of 10% to 50% by weight, based on the overall elastomer fraction. As representatives, mention may be made at this point, in particular, of the particularly compatible styrene-isoprene-styrene (SIS) and styrene-butadiene-styrene (SBS) types.

In one inventively preferred embodiment use is preferably made of (meth)acrylate PSAs.

(Meth)acrylate PSAs employed in accordance with the invention, which are obtainable by free-radical addition polymerization, preferably consist to the extent of at least 50% by weight of at least one acrylic monomer from the group of the compounds of the following general formula:

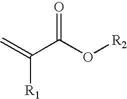

In this formula the radical R₁═H or CH₃ and the radical R₂═H or CH₃ or is selected from the group containing the branched and unbranched, saturated alkyl groups having 1-30 carbon atoms.

The monomers are preferably chosen such that the resulting polymers can be used, at room temperature or higher temperatures, as PSAs, particularly such that the resulting polymers possess pressure-sensitive adhesive properties in accordance with the “Handbook of Pressure Sensitive Adhesive Technology” by Donatas Satas (van Nostrand, N.Y. 1989).

In a further inventive embodiment the comonomer composition is chosen such that the PSAs can be used as heat-activable PSAs.

The polymers can be obtained preferably by polymerizing a monomer mixture which is composed of acrylic esters and/or methacrylic esters and/or the free acids thereof, with the formula CH₂═CH(R₁)(COOR₂), where R₁═H or CH₃ and R₂ is an alkyl chain having 1-20 C atoms or is H.

The molar masses M_{w} (weight average) of the polyacrylates used amount preferably to M_{w} 24 200 000 g/mol.

In one way which is very preferred, acrylic or methacrylic monomers are used which are composed of acrylic and methacrylic esters having alkyl groups comprising 4 to 14 C atoms, and preferably comprise 4 to 9 C atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethyl-hexyl acrylate, 2-ethylhexyl methacrylate, isooctyl acrylate, and isooctyl methacrylate, for example.

Further classes of compound which can be used are monofunctional acrylates and/or methacrylates of bridged cycloalkyl alcohols consisting of at least 6 C atoms. The cycloalkyl alcohols can also be substituted, by C-1-6 alkyl groups, halogen atoms or cyano groups, for example. Specific examples are cyclohexyl methacrylates, isobornyl acrylate, isobornyl methacrylates, and 3,5-dimethyladamantyl acrylate.

In an advantageous procedure monomers are used which carry polar groups such as carboxyl radicals, sulfonic and phosphonic acid, hydroxyl radicals, lactam and lactone, N-substituted amide, N-substituted amine, carbamate, epoxy, thiol, alkoxy or cyano radicals, ethers or the like.

Moderate basic monomers are, for example, N,N-dialkyl-substituted amides, such as, for example, N,N-dimethylacrylamide, N,N-dimethylmethylmethacrylamide, N-tert-butylacryl-amide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(buthoxymethyl)methacrylamide, N-methylolacrylamide, N-(ethoxymethyl)acrylamide, and N-isopropylacrylamide, this enumeration not being exhaustive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being exhaustive.

In one further very preferred procedure use is made as monomers of vinyl esters, vinyl ethers, vinyl halides, vinylidene halides, and vinyl compounds having aromatic rings and heterocycles in α-position. Here again, mention may be made, nonexclusively, of some examples: vinyl acetate, vinylformamide, vinylpyridine, ethyl vinyl ether, vinyl chloride, vinylidene chloride, and acrylonitrile.

Moreover, in one advantageous procedure, use is made of photoinitiators having a copolymerizable double bond. Suitable photoinitiators include Norrish I and II photoinitiators. Examples include benzoin acrylate and an acrylated benzophenone from UCB (Ebecryl P 36®). In principle it is possible to copolymerize any photoinitiators which are known to the skilled worker and which are able to crosslink the polymer by way of a free-radical mechanism under UV irradiation. An overview of possible photoinitiators which can be used and can be functionalized by a double bond is given in Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London is used as a supplement.

In another preferred procedure the comonomers described are admixed with monomers which possess a high static glass transition temperature. Suitable components include aromatic vinyl compounds, an example being styrene, in which the aromatic nuclei consist preferably of C₄ to C₁₈ units and may also include heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, this enumeration not being exhaustive.

As a result of the increase in the aromatic fraction there is a rise in the refractive index of the PSA, and the scattering between LCD glass and PSA as a result, for example, of extraneous light is minimized.

For further development it is possible to admix resins to the PSAs. As tackifying resins for addition it is possible to use without exception all tackifier resins previously known and described in the literature. Representatives that may be mentioned include pinene resins, indene resins, and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resultant adhesive in accordance with requirements. Generally speaking it is possible to employ any resins which are compatible (soluble) with the polyacrylate in question; in particular, reference may be made to all aliphatic, aromatic and alkylaromatics hydrocarbon resins, hydrocarbon resins based on single monomers, hydrogenated hydrocarbon resins, functional hydrocarbon resins, and natural resins. Reference is expressly made to the presentation of the state of knowledge in the “Handbook of Pressure Sensitive Adhesive Technology” by Donatas Satas (van Nostrand, 1989). Here as well, the transparency is improved using, preferably, transparent resins which are very highly compatible with the polymer. Hydrogenated or partly hydrogenated resins frequently feature these properties.

In addition it is possible optionally for plasticizers, further fillers (such as, for example, fibers, carbon black, zinc oxide, chalk, solid or hollow glass beads, microbeads made of other materials, silica, silicates), nucleators, electrically conductive materials, such as, for example, conjugated polymers, doped conjugated polymers, metal pigments, metal particles, metal salts, graphite, etc., expandants, compounding agents and/or aging inhibitors, in the form of, for example, primary and secondary antioxidants or in the form of light stabilizers, to have been added.

In a further advantageous embodiment of the invention the PSA (b) and/or (b′) comprises light-reflecting particles, such as white pigments (titanium dioxide or barium sulfate), for example, as a filler.

In addition it is possible to admix crosslinkers and promoters for crosslinking. Examples of suitable crosslinkers for electron beam crosslinking and UV crosslinking include difunctional or polyfunctional acrylates, difunctional or polyfunctional isocyanates (including those in blocked form), and difunctional or polyfunctional epoxides. In addition it is also possible for thermally activable crosslinkers to have been added, such as Lewis acid, metal chelates or polyfunctional isocyanates, for example.

For optional crosslinking with UV light it is possible to add UV-absorbing photoinitiators to the PSAs. Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime, for example.

The abovementioned photoinitiators and others which can be used, and also others of the Norrish I or Norrish II type, can contain the following radicals: benzophenone, acetophenone, benzil, benzoin, hydroxyalkylphenone, phenyl cyclohexyl ketone, anthraquinone, trimethylbenzoylphosphine oxide, methylthiophenylmorpholine ketone, aminoketone, azobenzoin, thioxanthone, hexaarylbisimidazole, triazine, or fluorenone, it being possible for each of these radicals to be additionally substituted by one or more halogen atoms and/or by one or more alkyloxy groups and/or by one or more amino groups or hydroxy groups. A representative overview is given by Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London can be used as a supplement.

### Preparation Process for the Acrylate PSAs

For the polymerization the monomers are chosen such that the resultant polymers can be used at room temperature or higher temperatures as PSAs, in particular such that the resulting polymers possess pressure-sensitive adhesive properties in accordance with the “Handbook of Pressure Sensitive Adhesive Technology” by Donatas Satas (van Nostrand, N.Y. 1989).

In order to achieve a preferred polymer glass transition temperature T_{g} of ≦25° C. for PSAs it is very preferred, in accordance with the comments made above, to select the monomers in such a way, and choose the quantitative composition of the monomer mixture advantageously in such a way, as to result in the desired T_{g} for the polymer in accordance with equation (E1) in analogy to the Fox equation (cf. T. G. Fox, Bull. Am. Phys. Soc. 1 (1956) 123).

$$\frac{1}{{T}_{g}} = {\sum }_{n} \frac{{w}_{n}}{{T}_{g , n}} \qquad ( E1 )$$

In this equation, n represents the serial number of the monomers used, wₙ the mass fraction of the respective monomer n (% by weight), and T_{g,n} the respective glass transition temperature of the homopolymer of the respective monomers n, in K.

For the preparation of the poly(meth)acrylate PSAs it is advantageous to carry out conventional free-radical polymerizations. For the polymerizations which proceed free-radically it is preferred to employ initiator systems which also contain further free-radical initiators for the polymerization, especially thermally decomposing, free-radical-forming azo or peroxo initiators. In principle, however, all customary initiators which are familiar to the skilled worker for acrylates are suitable. The production of C-centered radicals is described in Houben Weyl, Methoden der Organischen Chemie, Vol. E 19a, pp. 60-147. These methods are employed, preferentially, in analogy.

Examples of free-radical sources are peroxides, hydroperoxides, and azo compounds; some nonlimiting examples of typical free-radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred version the free-radical initiator used is 1,1′-azobis(cyclohexane-carbonitrile) (Vazo 88™ from DuPont) or azodiisobutyronitrile (AIBN).

The weight-average molecular weights M_{w} of the PSAs formed in the free-radical polymerization are very preferably chosen such that they are situated within a range of 200 000 to 4 000 000 g/mol; specifically for further use as electrically conductive hotmelt PSAs with resilience, PSAs are prepared which have average molecular weights M_{w} of 400 000 to 1 400 000 g/mol. The average molecular weight is determined by size exclusion chromatography (GPC) or matrix-assisted laser desorption/ionization plus mass spectrometry (MALDI-MS).

The polymerization may be conducted without solvent, in the presence of one or more organic solvents, in the presence of water, or in mixtures of organic solvents and water. The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether) or mixtures thereof. A water-miscible or hydrophilic cosolvent may be added to the aqueous polymerization reactions in order to ensure that the reaction mixture is present in the form of a homogeneous phase during monomer conversion. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

The polymerization time—depending on conversion and temperature—is between 2 and 72 hours. The higher the reaction temperature which can be chosen, i.e., the higher the thermal stability of the reaction mixture, the shorter the chosen reaction time can be.

As regards initiation of the polymerization, the introduction of heat is essential for the thermally decomposing initiators. For the thermally decomposing initiators the polymerization can be initiated by heating to from 50 to 160° C., depending on initiator type.

For the preparation it can also be of advantage to polymerize the (meth)acrylate PSAs without solvent. A particularly suitable technique for use in this case is the prepolymerization technique. Polymerization is initiated with UV light but taken only to a low conversion of about 10-30%. The resulting polymer syrup can then be welded, for example, into films (in the simplest case, ice cubes) and then polymerized through to a high conversion in water. These pellets can subsequently be used as acrylate hot-melt adhesives, it being particularly preferred to use, for the melting operation, film materials which are compatible with the polyacrylate. For this preparation method as well it is possible to add the thermally conductive materials before or after the polymerization.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

The living polymer is in this case generally represented by the structure P_{L}(A)-Me, where Me is a metal from group 1, such as lithium, sodium or potassium, and P_{L}(A) is a growing polymer from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, though this enumeration makes no claim to completeness. Furthermore, initiators based on samarium complexes are known for the polymerization of acrylates (Macromolecules, 1995, 28, 7886) and can be used here.

It is also possible, furthermore, to employ difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides, and alkylaluminum compounds. In one very preferred version the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

Methods suitable for preparing poly(meth)acrylate PSAs with a narrow molecular weight distribution also include controlled free-radical polymerization methods. In that case it is preferred to use, for the polymerization, a control reagent of the general formula:

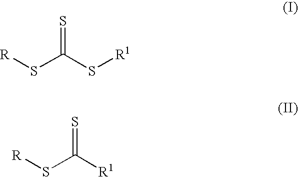

in which R and R¹ are chosen independently of one another or are identical, and
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂-C₁₈ heteroalkyl radicals having at least one oxygen atom and/or one NR* group in the carbon chain, R* being any radical (particularly an organic radical);
C₃-C₁₈ alkynyl radicals, C₃-C₁₈ alkenyl radicals, C₁-C₁₈ alkyl radicals substituted by at least one ester group, amine group, carbonate group, cyano group, isocyano group and/or epoxy group and/or by sulfur;
C₃-C₁₂ cycloalkyl radicals;
C₆-C₁₈ aryl or benzyl radicals;
hydrogen.

Control reagents of type (I) are preferably composed of the following further-restricted compounds:

Halogen atoms therein are preferably F, Cl, Br or I, more preferably Cl and Br. Outstandingly suitable alkyl, alkenyl and alkynyl radicals in the various substituents include both linear and branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlorohexyl.

An example of a suitable C₂-C₁₈ heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl, and other substituted phenyls, such as ethyl, toluene, xylene, mesitylene, isopropylbenzene, dichlorobenzene or bromotoluene.

The above enumerations serve only as examples of the respective groups of compounds, and make no claim to completeness.

Other compounds which can also be used as control reagents include those of the following types:

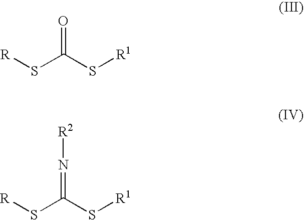

where R², again independently from R and R¹, may be selected from the group recited above for these radicals.

In the case of the conventional ‘RAFT’ process, polymerization is generally carried out only up to low conversions (WO 98/01478 A1) in order to produce very narrow molecular weight distributions. As a result of the low conversions, however, these polymers cannot be used as PSAs and in particular not as hotmelt PSAs, since the high fraction of residual monomers adversely affects the technical adhesive properties; the residual monomers contaminate the solvent recyclate in the concentration operation; and the corresponding self-adhesive tapes would exhibit very high outgassing behavior. In order to circumvent this disadvantage of low conversions, the polymerization in one particularly preferred procedure is initiated two or more times.

As a further controlled free-radical polymerization method it is possible to carry out nitroxide-controlled polymerizations. For free-radical stabilization, in a favorable procedure, use is made of nitroxides of type (Va) or (Vb):

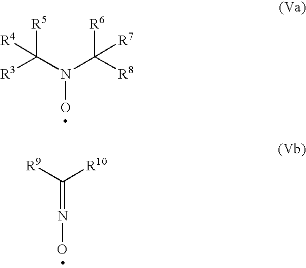

where R³, R⁴, R⁵, R⁶, R⁷, R⁸, R⁹, and R¹⁰ independently of one another denote the following compounds or atoms:
i) halides, such as chlorine, bromine or iodine, for example,
ii) linear, branched, cyclic, and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂, where R¹¹, R¹² or R¹³ stand for radicals from group ii).

Compounds of the formula (Va) or (Vb) can also be attached to polymer chains of any kind (primarily such that at least one of the abovementioned radicals constitutes a polymer chain of this kind) and may therefore be used for the synthesis of polyacrylate PSAs.

With greater preference, controlled regulators are used for the polymerization of compounds of the type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide.

A series of further polymerization methods in accordance with which the PSAs can be prepared by an alternative procedure can be chosen from the prior art:

U.S. Pat. No. 4,581,429 A discloses a controlled-growth free-radical polymerization process which uses as its initiator a compound of the formula R′R″N—O—Y, in which Y is a free-radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific free-radical compounds, such as phosphorus-containing nitroxides based on imidazolidine, for example, are employed. WO 98/44008 A1 discloses specific nitroxyls based on morpholines, piperazinones, and piperazinediones. DE 199 49 352 A1 describes heterocyclic alkoxyamines as regulators in controlled-growth free-radical polymerizations. Corresponding further developments of the alkoxyamines or of the corresponding free nitroxides improve the efficiency for the preparation of polyacrylates (Hawker, paper to the national meeting of the American Chemical Society, Spring 1997; Husemann, paper to the IUPAC World-Polymer Meeting 1998, Gold Coast).

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in the specifications U.S. Pat. No. 5,945,491 A, U.S. Pat. No. 5,854,364 A, and U.S. Pat. No. 5,789,487 A.

### Coating Process, Treatment of the Carrier Material

For production, in one preferred embodiment the pressure-sensitive adhesive is coated from solution onto the carrier material. To increase the anchoring of the PSA it is possible optionally to pretreat the layer (a). Thus pretreatment may be carried out, for example, by corona or by plasma. For the coating of the PSA from solution, heat is supplied, in a drying tunnel for example, to remove the solvent and, if appropriate, initiate the crosslinking reaction.

The polymers described above can also be coated, furthermore, as hotmelt systems (i.e., from the melt). For the production process it may therefore be necessary to remove the solvent from the PSA. In this case it is possible in principle to use any of the techniques known to the skilled worker. One very preferred technique is that of concentration using a single-screw or twin-screw extruder. The twin-screw extruder can be operated corotatingly or counterrotatingly. The solvent or water is preferably distilled off over two or more vacuum stages. Counterheating is also carried out depending on the distillation temperature of the solvent. The residual solvent fractions amount to preferably <1%, more preferably <0.5%, and very preferably <0.2%. Further processing of the hotmelt takes place from the melt.

For coating as a hotmelt it is possible to employ different coating processes. In one advantageous version the PSAs are coated by a roll coating process. Different roll coating processes are described in the “Handbook of Pressure Sensitive Adhesive Technology”, by Donatas Satas (van Nostrand, N.Y. 1989). In another version, coating takes place via a melt die. In a further preferred process, coating is carried out by extrusion. Extrusion coating is performed preferably using an extrusion die. The extrusion dies used may come advantageously from one of the three following categories: T-dies, fishtail dies and coathanger dies. The individual types differ in the design of their flow channels.

Through the coating it is also possible for the PSAs to undergo orientation.

In addition it may be necessary for the PSAs to be crosslinked. In one preferred version, crosslinking takes place thermally, with electron beams and/or UV radiation.

UV crosslinking irradiation is carried out with shortwave ultraviolet irradiation in a wavelength range from 200 to 400 nm, depending on the UV photoinitiator used; in particular, irradiation is carried out using high-pressure or medium-pressure mercury lamps at an output of 80 to 240 W/cm. The irradiation intensity is adapted to the respective quantum yield of the UV photoinitiator and the degree of crosslinking that is to be set.

Furthermore, in one advantageous embodiment of the invention, the PSAs are crosslinked using electron beams. Typical irradiation equipment which can be advantageously employed includes linear cathode systems, scanner systems, and segmented cathode systems, where electron beam accelerators are employed. A detailed description of the state of the art and the most important process parameters are found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably 80 kV and 300 kV. The scatter doses employed range between 5 and 150 kGy, in particular between 20 and 100 kGy.

It is also possible to employ both crosslinking processes, or other processes allowing high-energy irradiation.

The invention further provides for the use of the inventive double-sided pressure-sensitive adhesive tapes for the adhesive bonding or production of optical liquid-crystal data displays (LCDs), for the use for adhesively bonding LCD glasses, and also liquid-crystal data displays and devices comprising liquid-crystal data displays which have a pressure-sensitive adhesive tape of the invention in their product construction. For use as pressure-sensitive adhesive tape it is possible for the double-sided pressure-sensitive adhesive tapes to have been lined with one or two release films and/or release papers. In one preferred embodiment, use is made of siliconized or fluorinated films or papers, such as glassine, HDPE or LDPE coated papers, for example, which have in turn been given a release coat based on silicones or fluorinated polymers. One particularly preferred embodiment uses siliconized PET films as liners.

The pressure-sensitive adhesive tapes of the invention are particularly advantageous for the adhesive bonding of light-emitting diodes (LEDs), as a light source, to the LCD module.

### EXAMPLES

The invention is described below, without wishing any unnecessary restriction to result from the choice of the examples.

The following test methods were employed.

### Test Methods

The transmittance was measured in the wavelength range from 190 to 900 nm using a Uvikon 923 from Biotek Kontron. Measurement is made at 23° C. The absolute transmittance is reported in % as the value at 550 nm, relative to complete light absorption (0% transmittance=no light transmission; 100% transmittance=complete light transmission).

### B. Pinholes

A very strong light source of commercially customary type (e.g., Liesegangtrainer 400 KC type 649 overhead projector, 36 V halogen lamp, 400 W) is given completely lightproof masking. The mask contains in its center a circular aperture having a diameter of 5 cm. The double-sided LCD adhesive tape is placed atop said circular aperture. In a completely darkened environment, the number of pinholes is then counted electronically or visually. When the light source is switched on, these pinholes are visible as translucent dots.

### C. Reflection

The reflection test is carried out in accordance with DIN standards 5063 part 3 and 5033 parts 3 and 4. The instrument used was a type LMT Ulbricht sphere (50 cm diameter) in conjunction with a type LMT tau-ρ-meter digital display instrument. The integral measurements are made using a light source corresponding to standard light A and V(λ)-adapted Si photoelement. Measurement was carried out against a glass reference sample. The reflectance is reported as the sum of directed and scattered light fractions in %.

### Polymer 1

A 200 l reactor conventional for free-radical polymerizations was charged with 2400 g of acrylic acid, 64 kg of 2-ethylhexyl acrylate, 6.4 kg of methyl acrylate and 53.3 kg of acetone/isopropanol (95:5). After nitrogen gas had been passed through the reactor for 45 minutes with stirring, the reactor was heated to 58° C. and 40 g of 2,2′-azoisobutyronitrile (AIBN) were added. Subsequently the external heating bath was heated to 75° C. and the reaction was carried out constantly at this external temperature. After a reaction time of 1 h a further 40 g of AIBN were added. After 5 h and 10 h, dilution was carried out with 15 kg each time of acetone/isopropanol (95:5). After 6 h and 8 h, 100 g each time of dicyclohexyl peroxydicarbonate (Perkadox 16®, Akzo Nobel) in solution in each case in 800 g of acetone were added. The reaction was terminated after a reaction time of 24 h, and the reaction mixture cooled to room temperature. Before the composition is used for coating, polymer 1 is diluted with isopropanol to 30% solids content. Subsequently, with vigorous stirring, 0.3% by weight of aluminum(III) acetylacetonate (3% strength solution, isopropanol), based on polymer 1, is mixed in.

### Film (Al Vapor Coating):

A 12 μm or 38 μm thick PET film (12 μm, e.g., from Mitsubishi (Hostaphan™ 5210, 38 μm, e.g., from Toray Lumirror™ 38E20) is vapor-coated on one or both sides with aluminum until a full-area aluminum layer had been applied. The film was vapor-coated in a width of 300 mm by the sputtering method. In this method, positively charged, ionized argon gas is passed into a high-vacuum chamber. The charged ions then impinge on a negatively charged Al plate and, at the molecular level, detach particles of aluminum, which then deposit on the polyester film which is passed over the plate.

Coating Material 1

In a Red Devil paint mixer, 42 parts of Acrydic A-910 (nitrogen-containing acrylic resin with a solids fraction of 50%, from Dainippon Ink and Chemicals), 80 parts of Titanweiss [titanium white] JR603 (Teikoku Kako Co. Ltd.), 6 parts of xylene, 6 parts of toluene, 6 parts of methyl ethyl ketone are dispersed for 30 minutes. Further homogenization then follows in an Ultraturrax.

### Example 1

The coating composition 1 is applied evenly using a Meyer Bar to the 12 μm PET film, aluminized on both sides, and is dried at 120° C. for 10 minutes. The application weight is 8 g/m².

Then polymer 1 is applied evenly from solution to this coat and is dried at 100° C. for 10 minutes. The coat weight for this coat is 50 g/m². The side is lined with a double-sidedly siliconized PET film 50 μm thick. Then, on the opposite side, the coating composition 1 is applied evenly with a Meyer Bar and dried at 120° C. for 10 minutes. The application weight is 8 g/m². Subsequently polymer 1 is then applied evenly at 50 g/m², and drying takes place again at 100° C. for 10 minutes.

### Example 2

The coating composition 1 is applied evenly using a Meyer Bar to a 38 μm PET film, extruded with white pigments as filler, from Toray (Lumirror™ 38E20) and aluminized on both sides, and is dried at 120° C. for 10 minutes. The application weight is 8 g/m².

Then polymer 1 is applied evenly from solution to this coat and is dried at 100° C. for 10 minutes. The coat weight for this coat is 50 g/m². The side is lined with a double-sidedly siliconized PET film 50 μm thick. Then, on the opposite side, the coating composition 1 is applied evenly with a Meyer Bar and dried at 120° C. for 10 minutes. The application weight is 8 g/m². Subsequently polymer 1 is then applied evenly at 50 g/m², and drying takes place again at 100° C. for 10 minutes.

### Example 3

The coating composition 1 is applied evenly using a Meyer Bar to the 12 μm PET film, aluminized on one side, and is dried at 120° C. for 10 minutes. The application weight is 8 g/m².

Then polymer 1 is applied evenly from solution to this coat and is dried at 100° C. for 10 minutes. The coat weight for this coat is 50 g/m². The side is lined with a double-sidedly siliconized PET film 50 μm thick. Then, on the opposite side, the coating composition 1 is applied evenly with a Meyer Bar and dried at 120° C. for 10 minutes. The application weight is 8 g/m². Subsequently polymer 1 is then applied evenly at 50 g/m², and drying takes place again at 100° C. for 10 minutes.

### Example 4

The coating composition 1 is applied evenly using a Meyer Bar to a 38 μm PET film, extruded with white pigments as filler, from Toray (Lumirror™ 38E20) and aluminized on one side, and is dried at 120° C. for 10 minutes. The application weight is 8 g/m².

Then polymer 1 is applied evenly from solution to this coat and is dried at 100° C. for 10 minutes. The coat weight for this coat is 50 g/m². The side is lined with a double-sidedly siliconized PET film 50 μm thick. Then, on the opposite side, the coating composition 1 is applied evenly with a Meyer Bar and dried at 120° C. for 10 minutes. The application weight is 8 g/m². Subsequently polymer 1 is then applied evenly at 50 g/m², and drying takes place again at 100° C. for 10 minutes.

### Results

Examples 1 and 2 are examples of the inventive version of the use of two metallic layers for light absorption and hence for the reduction of light transmission. In example 2a white carrier film was used. Examples 3 and 4 are examples of the inventive version of the use of a metallic layer for light absorption and hence for reducing light transmission.

Example 3 is an example of the use of a thin transparent film, example 4 an example of the use of a thicker white film.

Examples 1 to 4 were tested according to test methods A, B and C. The results are shown in table 1.

TABLE 1

| | Transmittance | Pinholes | Reflectance (total) |
|---|---|---|---|
| Example | (test A) | (test B) | (test C) |
| Example 1 | <0.1% | 0 | 76.1% |
| Example 2 | <0.1% | 0 | 76.4% |
| Example 3 | <0.1% | 0 | 72.1% |
| Example 4 | <0.1% | 0 | 71.8% |

From the results from table 1 it is apparent that examples 1 to 4 have outstanding properties in terms of optical defects (absence of pinholes) and transmittance. With test C, furthermore, it has been shown that examples 1 to 4 not only have light-absorbing properties but also possess very high light-reflecting properties. For the case of application in the LCD this means that the light yield in the light channel is significantly increased. Additionally it has been shown that for the production of a light-reflecting and light-absorbing tape it is not absolutely necessary to use a double-sided pressure-sensitive adhesive tape which has to be black on one side and light-reflecting (i.e., white or metallic) on the other side.

1-8. (canceled)

9. A pressure-sensitive adhesive tape for the production or adhesive bonding of optical liquid-crystal data displays, comprising
two pressure-sensitive adhesive layers,
at least one carrier film, and
wherein the pressure-sensitive adhesive tape has light-reflecting properties both on its top side and on its bottom side and at the same time is light-absorbing at least insofar as light which is not reflected is unable to penetrate the adhesive tape.

10. A pressure-sensitive adhesive tape for the production or adhesive bonding of optical liquid-crystal data displays, comprising
two pressure-sensitive adhesive layers,
at least one carrier film,
a white coating layer provided at least between one side of the carrier film and the pressure-sensitive adhesive layer located on that side.

11. The pressure-sensitive adhesive tape of claim 10, further comprising a metallic layer disposed between the carrier film and the white coating layer.

12. A pressure-sensitive adhesive tape for the production or adhesive bonding of optical liquid-crystal data displays, two pressure-sensitive adhesive layers,
at least one carrier film,
a white coating layer provided on both sides between the carrier film and the respective pressure-sensitive adhesive layer.

13. The pressure-sensitive adhesive tape of claim 12, wherein a metallic layer is provided on both sides in each case between the carrier film and the respective coating layer.

14. A method of using a pressure-sensitive adhesive tape of claim 9 for producing or adhesively bonding optical liquid-crystal data displays.

15. The method of using according to claim 14 for adhesively bonding LCD glasses.

16. A liquid-crystal data display device comprising a pressure-sensitive adhesive tape of claim 9.

17. The pressure-sensitive adhesive tape of claim 11, wherein the metallic layer is a layer provided by metallization.

18. The pressure-sensitive adhesive tape of claim 13, wherein the metallic layer is a layer provided by metallization
